(19) United States
(12) Patent Application Publication
(10) Pub. No.: US 2026/0054480 A1
(43) Pub. Date: Feb. 26, 2026

(54) LIQUID EJECTION HEAD

(71) Applicant: CANON KABUSHIKI KAISHA, Tokyo (JP)

(72) Inventors: TAKASHI KATO, Kanagawa (JP); YOSHIYUKI NAKAGAWA, Kanagawa (JP); TOSHIO NEGISHI, Kanagawa (JP)

(21) Appl. No.: 19/307,599

(22) Filed: Aug. 22, 2025

(30) Foreign Application Priority Data
Aug. 26, 2024 (JP) 2024-144361

(51) Int. Cl. B41J 2/045; B41J 2/14

(52) U.S. Cl. CPC B41J 2/04573; B41J 2/04541; B41J 2/0455; B41J 2/0458; B41J 2/1404; B41J 2/1412; B41J 2202/07; B41J 2202/12

(57) ABSTRACT

A liquid ejection head includes a first individual ejection unit, a second individual ejection unit, and a common flow passage for supplying liquid. The first individual ejection unit and the second individual ejection unit each include an ejection port, a pressure chamber, a first energy generating element that is provided in the pressure chamber, an individual flow passage that communicates with the pressure chamber, and a second energy generating element that is provided in the individual flow passage. The liquid ejection head is characterized in that the first and second energy generating elements in each ejection unit are controlled differently for each individual ejection unit at a common driving timing, by a common driving pulse.

### BACKGROUND

### Field of the Technology

The present disclosure relates to a liquid ejection head.

### Description of the Related Art

A circulation type liquid ejection device is known that circulates ink in order to discharge bubbles in a flow passage and suppress an increase in viscosity of ink near the ejection port in a liquid ejection head (hereinafter also referred to as “head”). A method using a pressure difference (hereinafter also referred to as a “differential pressure method”) is well known as a method for circulating ink. In such a method, a pressure adjustment mechanism or the like is used to make a pressure higher on a side on which ink is supplied to the ejection port (inner side) than on a side on which ink is collected (outer side), thereby causing ink to flow from the inner side to the outer side. In such a case, in order to circulate the ink, it is necessary to return the ink, which flows to the outer side, to the inner side, and a pump is used as a mechanism therefor. Alternatively, a pump may be provided outside of the head such as on a recording device body to circulate the liquid between the liquid ejection head and the body, or a pump may be provided inside of the liquid ejection head to circulate the liquid in the liquid ejection head. However, such a differential pressure circulation method uses mechanisms such as a pressure adjustment mechanism and a pump, and the recording device body and the head tend to be large in size.

Therefore, ink circulation methods other than the differential pressure method have been considered. Specifically, a mechanism is known in which a circulation flow passage is provided that communicates with the ejection port, an energy generating element (hereinafter also referred to as a “flow energy generating element”) other than the energy generating element for ejecting ink (hereinafter also referred to as an “ejection energy generating element”) is disposed in the circulation flow passage, and the ink is circulated in a circulation path by driving the flow energy generating element.

Japanese Patent Application Publication No. 2020-104312 discloses a configuration in which the circulation flow passage is provided that extends to intersect with the ejection port row in which a plurality of ejection ports is arranged and the flow energy generating element is provided in the circulation path.

Japanese Patent Application Publication No. 2020-104312 does not describe what kind of driving pulse or driving timing is used to drive the ejection energy generating element and the flow energy generating element. In general, it is conceivable that the driving of only the ejection energy generating element is diverted to give driving pulse waveforms corresponding to the respective energy generating elements, and the driving timing is set to provide a delay for each time-division block while distributing each driving pulse waveform under time-division control. However, a problem arises in that the circuit size increases depending on the types and the number of energy generating elements.

Therefore, it would be useful to reduce the circuit size in the ink circulation type liquid ejection head that uses both the ejection energy generating element and the flow energy generating element.

### SUMMARY

The present disclosure advantageously provides features to address these issues and, according to some embodiments, a liquid ejection head includes a first individual ejection unit; a second individual ejection unit; and a common flow passage, wherein the first individual ejection unit and the second individual ejection unit each include an ejection port configured to eject liquid, a pressure chamber that communicates with the ejection port, a first energy generating element that is provided in the pressure chamber and configured to generate energy for ejecting the liquid from the ejection port, an individual flow passage that communicates with the pressure chamber, and a second energy generating element that is provided in the individual flow passage, wherein the common flow passage supplies the liquid to the individual flow passage for each of the first individual ejection unit and the second individual ejection unit, wherein the first energy generating element and the second energy generating element in each of the first individual ejection unit and the second individual ejection unit are all driven by a common driving pulse, wherein the first energy generating element and the second energy generating element in the first individual ejection unit are driven at the same timing which is a first timing, wherein the first energy generating element and the second energy generating element in the second individual ejection unit are driven at the same timing which is a second timing, and wherein the first timing and the second timing are controlled to be different from each other.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are diagrams of a device using a liquid ejection head.

FIGS. 2A to 2D are diagrams of an overall liquid ejection head and an overall liquid ejection chip.

FIGS. 3A to 3D are schematic diagrams of the vicinity of an ejection port of the liquid ejection head.

FIGS. 4A to 4C are schematic diagrams of the vicinity of an ejection port of the liquid ejection head.

FIGS. 5A to 5D are schematic diagrams of the vicinity of an ejection port of the liquid ejection head.

FIGS. 6A to 6D are schematic diagrams of the vicinity of an ejection port of the liquid ejection head.

FIGS. 7A to 7C are schematic diagrams of the vicinity of an ejection port of a liquid ejection head in a first embodiment.

FIG. 8 is a circuit configuration diagram in a comparative configuration.

FIG. 9 is a first circuit configuration diagram in the first embodiment.

FIG. 10 is a second circuit configuration diagram in the first embodiment.

FIGS. 11A to 11C are schematic diagrams of the vicinity of an ejection port of a liquid ejection head in a second embodiment.

FIGS. 12A to 12C are schematic diagrams of the vicinity of an ejection port of a liquid ejection head in a third embodiment.

FIGS. 13A and 13B are schematic diagrams of the vicinity of an ejection port of a liquid ejection head in a fourth embodiment.

FIGS. 14A and 14B are schematic diagrams of the vicinity of an ejection port of a liquid ejection head in a fifth embodiment.

FIGS. 15A to 15C are schematic diagrams of the vicinity of an ejection port of a liquid ejection head in a sixth embodiment.

### DESCRIPTION OF THE EMBODIMENTS

Now, various exemplary embodiments, features, and aspects of the present disclosure will be described in detail with reference to the accompanying drawings. Note that the following embodiments do not limit the items of the present disclosure, and not all combinations of features described in the present embodiments are necessarily essential to the solution of the present disclosure. The same constituent elements are represented by the same reference numerals and signs. In the following description, the basic configuration of the present disclosure will be described first, and then the features of the present disclosure will be described.

### Liquid Ejection Device

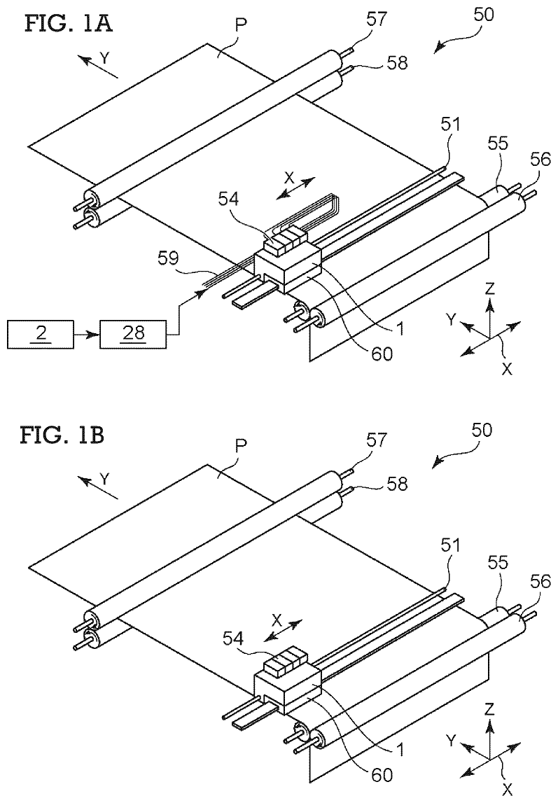

First, a schematic configuration of a liquid ejection device 50 in the present embodiment will be described. FIGS. 1A and 1B are enlarged views of a liquid ejection head 1 of the liquid ejection device 50 and the periphery thereof. FIGS. 1A and 1B are perspective views schematically illustrating a liquid ejection device using a liquid ejection head. The liquid ejection device 50 illustrated in FIGS. 1A and 1B is a liquid ejection device (serial type liquid ejection device) that performs image recording by ejecting liquid onto a recording medium P using a liquid ejection head that scans in a direction intersecting with a transport direction of the recording medium P. The present disclosure is not limited to the serial type liquid ejection device, but is also applicable to a page wide type liquid ejection device that to perform image recording by using a line head (page wide type head), which is long in a page width direction of the recording medium, to eject liquid onto a recording medium transported in the transport direction. The liquid ejection head in the present embodiment is capable of ejecting four types of inks including black (K), cyan (C), magenta (M), and yellow (Y), and full-color images can be recorded using such inks. The inks that can be ejected from the liquid ejection head are not limited to the four types of inks described above. The present disclosure is also applicable to liquid ejection heads for ejecting other types of inks. That is, the types and the number of inks ejected from the liquid ejection head are not limited.

In a serial type liquid ejection device 50, the liquid ejection head 1 is mounted on a carriage 60. The carriage 60 moves back and forth along a guide shaft 51 in a main scanning direction (X direction). The recording medium is transported in a sub-scanning direction (Y direction) that intersects with (in the present example, is perpendicular to) the main scanning direction by transport rollers (transport means) 55, 56, 57, and 58. In each figure referred to below, the Z direction indicates the vertical direction and intersects (in the present example, is perpendicular to) with the X-Y plane defined by the X and Y directions.

FIG. 1A shows a configuration in which a main ink tank 2 is provided as a liquid retention portion outside of the liquid ejection head. The liquid (ink) retained in the ink tank 2 is supplied to a sub-ink tank 54 on the liquid ejection head 1 side through an ink supply tube (liquid communication path) 59 by the driving force of an external pump 28. In contrast, FIG. 1B shows a configuration in which the ink tank 54 is provided directly above the liquid ejection head 1 (without the main ink tank 2 as the liquid retention portion outside of the liquid ejection head). In such a case, the liquid ejection head 1 may be provided integrally with the ink tank 54 and configured such that the carriage 60 is removable therefrom and attachable thereto. Alternatively, the liquid ejection head 1 may be provided integrally with the carriage 60 and configured such that only the ink tank 54 is removable therefrom and attachable thereto. The following description will be given using the configuration of FIG. 1A as a representative example.

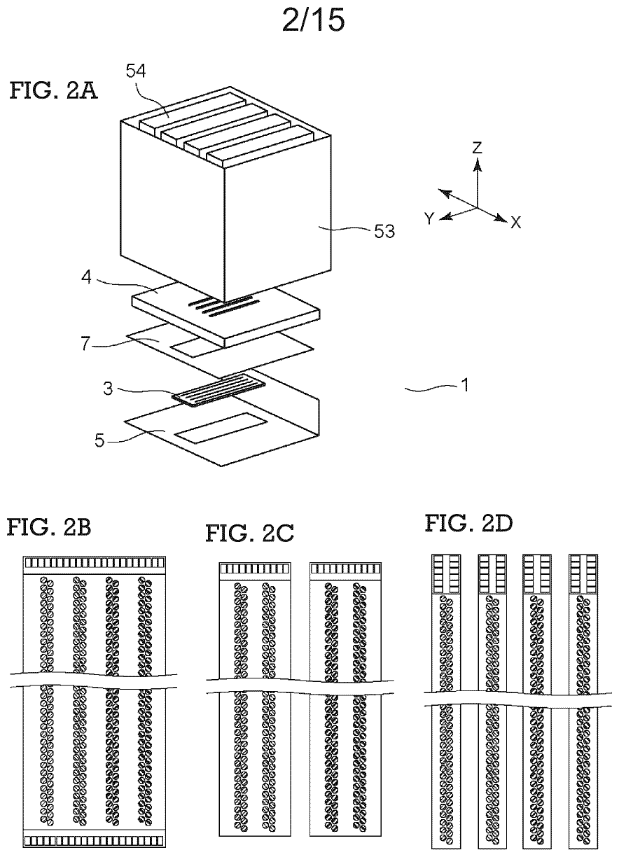

The liquid ejection head 1 is configured to include individual ejection units (refer to FIGS. 2A to 2D) to be described later. Although a specific configuration thereof will be described later, the individual ejection unit is provided with an ejection port for ejecting liquid, a pressure chamber communicating with the ejection port, a first energy generating element (ejection energy generating element) provided in the pressure chamber and generating energy for ejecting liquid from the ejection port, an individual flow passage communicating with the pressure chamber, and a second energy generating element (flow energy generating element) provided in the individual flow passage. The liquid ejection head 1 has a plurality of individual ejection units, and has an opening as a supply flow passage for supplying a liquid to the individual flow passage in each individual ejection unit.

When the liquid ejection head is used, the ejection of liquid may become unstable due to evaporation of volatile components such as water from the ejection port and the resulting solid content concentration near the ejection port, and various measures are considered to prevent the situation. For example, the liquid ejection device may be provided with a cap member (not illustrated in the drawing) capable of covering the ejection port surface on which the ejection port of the liquid ejection head is formed, at a position shifted from the transport path of the recording medium in the X direction. The cap member is used to cover the ejection port surface of the liquid ejection head when the recording operation is not being performed, and to prevent the ejection port from drying and to protect the ejection port. Further, an ink suction mechanism (not illustrated in the drawing) may be provided. In such a case, the cap member is used for the operation of suctioning ink from the ejection ports. By performing the ink suction operation, the ink near the ejection port can be refreshed, and the quality level of the image quality to be obtained can be maintained. Furthermore, there are known methods of discarding concentrated ink by performing ejection which is referred to as preliminary ejection (pre-ejection) when the recording operation is not being performed, and of preliminarily ejecting ink (sheet preliminary ejection or intra-page preliminary ejection) at an unnoticeable position and with an inconspicuous amount in terms of image quality on the recording medium even during the recording operation. Although such methods contribute greatly to improving image quality, an amount of waste ink may be minimized since some ink is discarded to refresh the ejection ports.

To solve such a problem, a second energy generating element (flow energy generating element) is provided in the individual flow passage and the ink is circulated in the flow passage. Thereby, it is possible to prevent the ejection port from being dried and prevent the ink near the ejection port from being concentrated while minimizing the amount of waste ink. More specifically, the number of preliminary ejection operations and the number of suction recovery operations can be reduced as much as possible. Further, if the number of preliminary ejection operations and the like can be minimized as much as possible, the throughput and yield can also be improved.

The second energy generating elements (flow energy generating elements) do not have to be provided in all individual ejection units of the liquid ejection head. When the elements are provided in some of the individual ejection units, the above-mentioned effect can be obtained compared to a case where the elements are not provided.

Further, the liquid ejection head illustrated in FIG. 1A may be configured such that all locations corresponding to the four types of inks are provided with the second energy generating elements, or such that only a location corresponding to one type of ink is provided with the second energy generating element. In other words, the liquid ejection head may be configured to not circulate all the four types of inks but only at least one type of ink.

### Basic Configuration of Liquid Ejection Head

FIG. 2A is an exploded perspective view of the liquid ejection head according to the present embodiment. As illustrated in FIGS. 2A to 2D, the liquid ejection head is configured to include the sub-ink tank 54 that temporarily retains ink in the head, and a liquid ejection chip 3 that ejects the ink supplied from the sub-ink tank 54 onto the recording medium P. The liquid ejection head according to the present embodiment is fixedly supported on the carriage of the liquid ejection device by a positioning means and an electric contact (not illustrated in the drawing) provided on the carriage. The liquid ejection head ejects the ink while moving together with the carriage in the main scanning direction (X direction) illustrated in FIGS. 1A and 1B, thereby performing recording on the recording medium P.

Ink supply tubes 59 are provided on the external pumps 28 connected to the ink tanks 2, each of which serves as an ink supply source (refer to FIG. 1A). Liquid connectors (not illustrated) are provided at leading ends of the ink supply tubes. When the liquid ejection head 1 is mounted on the liquid ejection device 50, the liquid connectors provided at the leading ends of the ink supply tubes 59 are liquid-tightly connected to liquid connector insertion ports, which are liquid inlet ports provided on a head housing of the liquid ejection head 1. Thereby, an ink supply path is formed to range from the ink tank 2 through the external pump 28 to the liquid ejection head 1. In the present embodiment, since four types of inks are used, four sets of the ink tanks 2, the external pumps 28, the ink supply tubes 59, and the sub-ink tanks 54 are provided corresponding to the respective inks, and four ink supply paths corresponding to the respective inks are independently formed. As described above, the liquid ejection device according to the present embodiment is provided with an ink supply system to which the inks are supplied from the ink tanks 2 provided outside of the liquid ejection head 1. Note that the liquid ejection device according to the present embodiment is not provided with an ink collecting system that collects the inks in the liquid ejection head to the ink tanks. Therefore, the liquid ejection head is provided with the liquid connector insertion ports for connecting the ink supply tubes of the ink tanks, but is not provided with connector insertion ports for connecting tubes for collecting the inks in the liquid ejection head to the ink tanks. Note that the liquid connector insertion port is provided for each ink.

FIGS. 2B, 2C, and 2D are overall diagrams of liquid ejection chips constituting the liquid ejection head. FIG. 2B shows a configuration of one chip for four colors, FIG. 2C shows a configuration of one chip for two colors, and FIG. 2D shows a configuration of one chip for one color. Each liquid ejection chip is provided with the ejection port and a pad used for electrical mounting. FIG. 2A shows the chip configuration of FIG. 2B.

FIG. 2B shows a first embodiment in which one chip is provided for four colors. The four colors are, for example, black, cyan, magenta, and yellow, and respective rows for the respective colors are aligned in the Y direction. The ejection ports in each row are adjacent and shifted in the X direction, and are disposed at equal intervals along the Y direction. Here, the ejection ports in each row may be disposed in a row along the Y direction without being shifted in the X direction. In addition, two rows may be provided for black, and a total of five rows may be provided for the four colors.

FIG. 2C shows a second embodiment in which two chips are used such that each one chip is provided for two colors. When two chips are mounted on the liquid ejection head, two chips may be mounted on one liquid ejection head, or two liquid ejection heads may be provided such that each one chip is mounted on each one liquid ejection head.

FIG. 2D shows a third embodiment in which four chips are used such that each one chip is provided for one color. As in FIG. 2C, four chips may be mounted on one liquid ejection head, or four liquid ejection heads each having one chip mounted thereon may be provided.

Further, as illustrated in FIGS. 2C and 2D, when the chip is divided into a plurality of chips, all the chips do not have to have the same chip length. Furthermore, various combinations for a different number of colors for the chips can be made, and the same applies when the total number of colors is greater than four.

### Constituent Elements of Circulation Unit

### Straight Type

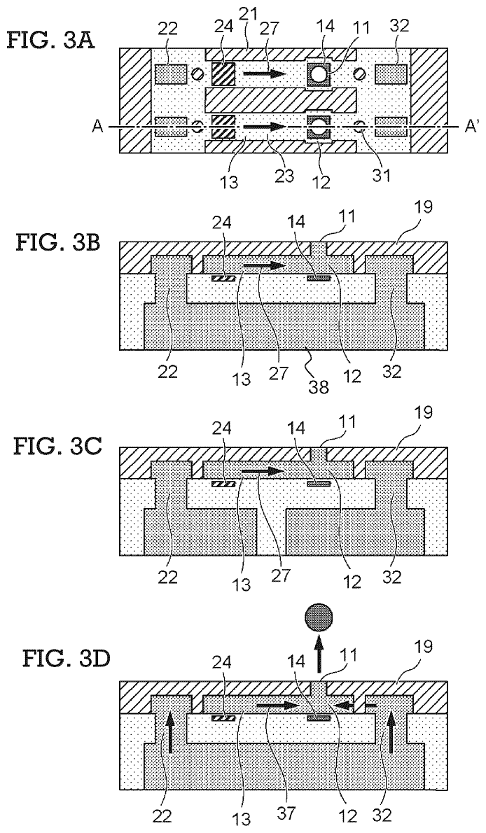

FIGS. 3A to 3D are schematic diagrams each illustrating the vicinity of an ejection port of a straight type liquid ejection head. In the present specification, the “straight type” means a straight shape that extends in a direction intersecting with the ejection port row (in FIGS. 3A to 3D, a direction perpendicular to the ejection port row) such that both end portions of the individual flow passage, in which the first energy generating element (ejection energy generating element) and the second energy generating element (flow energy generating element) are disposed, are located on both sides of the ejection port row interposed therebetween. In other words, the first energy generating element and the second energy generating element are disposed in the individual flow passage of the individual ejection unit in a direction intersecting with the ejection port row.

FIG. 3A is a plan view as viewed from the direction in which liquid droplets are ejected from the ejection port. FIG. 3B is a cross-sectional view taken along the line A-A′ in FIG. 3A. FIG. 3C is another cross-sectional view taken along the line A-A′ in FIG. 3A. FIG. 3D is a diagram illustrating the ink flow when the first energy generating element is driven.

In FIGS. 3A to 3C, pressure chambers 12 partitioned by partition walls 21 and corresponding to the respective ejection ports 11 and individual flow passages 23 for flowing ink through the pressure chambers 12 are formed, between a substrate 18 and an orifice plate 19. A meniscus of the ink is stretched over the ejection port 11, and an ejection port interface is formed as an interface between the ink and the atmosphere.

The substrate 18 is provided with a first energy generating element 14 that generates energy for ejecting ink in the pressure chamber. In the present example, an electro-thermal conversion element is used. The first energy generating element 14 is located closer to a second supply opening 32 (second opening) than to a first supply opening 22 (first opening), together with the ejection port 11 and the pressure chamber 12. The first energy generating element 14 is driven to generate heat to foam the ink in the pressure chamber 12, and the ink can be ejected from the ejection port 11 by using the foam energy. The first energy generating element is not limited to the electro-thermal conversion element as in the present example, and a piezoelectric element or the like may be used.

Further, the substrate 18 is provided with a second energy generating element 24 that generates energy to generate a circulation flow 27 of the ink in the individual flow passage as indicated by the arrows. In the present example, the electro-thermal conversion element is used. Therefore, the second energy generating element 24 is also referred to as a circulation heater 24.

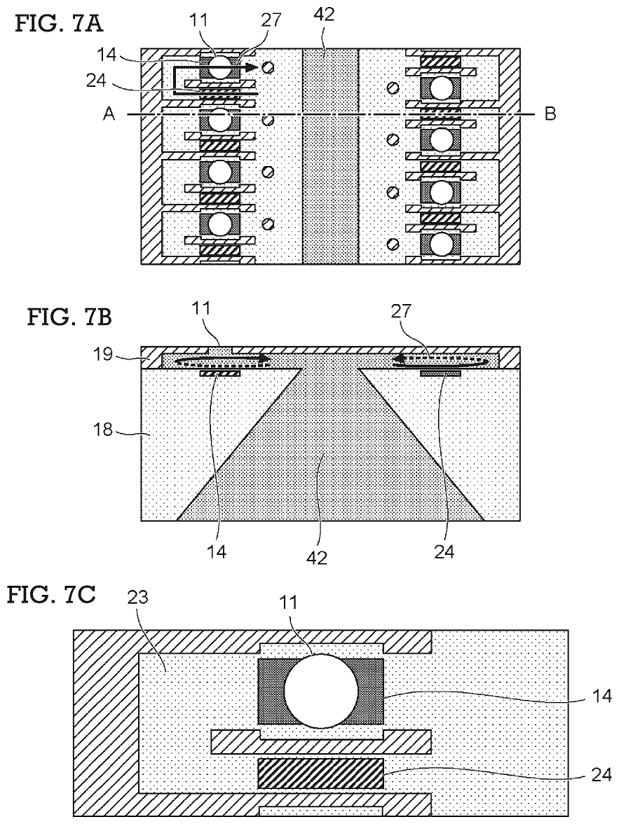

The substrate 18 is further provided with an opening for supplying liquid from the common flow passage to the individual flow passages. The opening may be configured as a plurality of openings (independent supply openings) as illustrated in FIG. 3A, or may be a supply groove as a single large opening as illustrated in FIG. 7A to be described later. The second energy generating element 24 is located closer to the first supply opening 22 than the second supply opening 32.

The individual flow passages 23 extend in a second direction intersecting with (in the present example, perpendicular to) the direction (first direction) in which the ejection ports are arranged in a row. The individual flow passages 23 include the pressure chamber 12, the inlet (upstream) side connection flow passage 13 in FIG. 3B communicating with one end portion of the pressure chamber 12, and the outlet (downstream) side flow passage in FIG. 3B communicating with the other end portion of the pressure chamber 12. The individual flow passages 23 respectively communicate with the first supply opening 22 and the second supply opening 32 that penetrate the substrate 18, at one end on the upstream side and the other end on the downstream side. Therefore, the connection flow passage 13 is located closer to the second energy generating element than the ejection port row. Both end portions of the individual flow passage 23 are located on opposite sides to each other with the ejection port row interposed therebetween. The first supply opening 22 and the second supply opening 32 are supplied with liquid from a common flow passage 38.

The ink flow in the individual flow passage is roughly divided into the following two types: (1) a first ink flow for driving the first energy generating element 14 and refilling after ejection, and (2) a second ink flow for driving the second energy generating element 24 and forming the circulation flow.

When the first energy generating element 14 is driven to eject liquid from the ejection port 11, the ink is supplied in accordance with the ejection from the first supply opening 22 and the second supply opening 32 as illustrated in FIG. 3D. Therefore, ink flows into the pressure chamber from both supply openings.

When the second energy generating element 24 is driven to form a circulation flow, ink flows into the individual flow passage 23 through the first supply opening 22, which is on the connection flow passage side, and flows out to the outside through the second supply opening 32, which is not on the connection flow passage side. In the present example, the ink flowing out from the second supply opening 32 is returned to the first supply opening 22 and circulated to form the circulation flow 27, which is indicated by the arrow, in the individual flow passage 23. Further, in a configuration illustrated in FIG. 3B, the first supply opening 22 and the second supply opening 32 may be shared within the chip. Furthermore, in a configuration illustrated in FIG. 3C, the first supply opening 22 and the second supply opening 32 may be connected to individual flow passages and shared outside of the recording head. Either of the above-mentioned configurations may be adopted.

Filters 31 for removing foreign matter from the ink may be provided in the ink circulation flow passages inside and outside of the recording head. In FIGS. 3A to 3D, the filters are disposed outside of the individual flow passage, on the inflow side and outflow side of the individual flow passage. Further, the filter may be disposed between the first energy generating element and the second energy generating element in the individual flow passage. In such a case, the filter does not have to be disposed on the upstream side (second energy generating element side) which is the outer side of the individual flow passage.

### U-Shape Type

The vicinity of the ejection port of a U-shape type liquid ejection head will be described using FIGS. 7A to 7C of the first embodiment to be described later. In the present specification, the “U-shape type” means that a flow passage, in which the first energy generating element (ejection energy generating element) and the second energy generating element (flow energy generating element) are disposed, is formed in a U-shape. That is, in the individual flow passage, the first energy generating element and the second energy generating element are disposed along the ejection port row. In addition, the individual flow passage is configured such that both end portions are located on a single side of the ejection port row. FIG. 7A is a plan view as viewed from the direction in which liquid droplets are ejected from the ejection ports. FIG. 7B is a cross-sectional view taken along the line A-B in FIG. 7A. FIG. 7C is an enlarged schematic diagram illustrating the names of elements in the individual flow passage portion in FIG. 7A.

In FIGS. 7A to 7C, the first energy generating element 14 and the second energy generating element 24 are both located near the supply groove 42. The individual flow passages 23 are formed in a bent shape (U-shape) such that the first energy generating elements and the second energy generating elements are alternately arranged in the direction (first direction) in which the ejection ports are arranged in a row, and are connected to each other. The individual flow passages 23 include the pressure chamber 12, the inlet (upstream) side connection flow passage 13 in FIG. 7B that communicates with one end portion of the pressure chamber 12, and the outlet (downstream) side flow passage in FIG. 7B that communicates with the other end portion of the pressure chamber 12. The individual flow passages 23 communicate with the supply groove 42 that penetrates the substrate 18 on both the upstream and downstream sides. Both end portions of the individual flow passages 23 are located adjacent on a single side of the supply groove 42.

The ink flows in the individual flow passages of the type are classified into two types, (1) the first ink flow and (2) the second ink flow, as in the straight type.

When the first energy generating element 14 is driven and the liquid is ejected from the ejection port 11, the ink is supplied from the supply groove 42 in accordance with the ejection. Thus, the ink flows into the pressure chamber from both the connection flow passage side and the opposite side.

When the second energy generating element 24 is driven and a circulation flow is formed, the ink flows into the individual flow passage 23 from the inlet (upstream) side, which is the connection flow passage side, and flows out to the outlet (downstream) side. In the present example, both flow into and out of the common supply groove 42, forming a circulation flow 27 indicated by the arrow in the individual flow passage 23. Note that although shown in the present embodiment, the supply groove 42 may be replaced with supply opening rows arranged in the first direction as illustrated in FIGS. 3A to 3D. When the supply groove 42 is replaced with the supply opening, the supply opening is configured to be shared within the chip as in FIG. 3B.

### Pump Principle

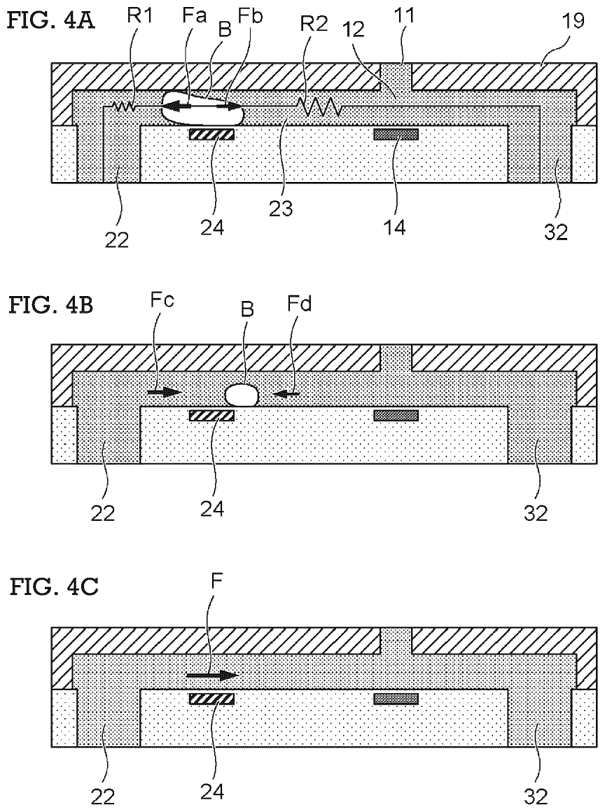

FIGS. 4A to 4C are diagrams illustrating the principle of generation of the circulation flow of ink when using the second energy generating element (circulation heater) 24 which is an electro-thermal conversion element. FIGS. 4A, 4B, and 4C are cross-sectional views similar to FIG. 3B, respectively illustrating a process of generation and growth of bubble B, a process of shrinkage of the bubble B, and a process after collapse of the bubble B. The bubble B is caused by film boiling of ink when the circulation heater 24 heats the ink. In FIG. 4A, the circulation heater 24 is located closer to the first supply opening 22 than the second supply opening 32. Therefore, a flow resistance R1 between the circulation heater 24 and the first supply opening 22 is less than a flow resistance R2 between the circulation heater 24 and the second supply opening 32. FIG. 4A includes an equivalent circuit that expresses such flow resistances R1 and R2 as electrical resistances. The bubble B generated by the film boiling of the ink grows biased toward the first supply opening 22 side with the smaller flow resistance R1, as illustrated in FIG. 4A, due to the difference between the flow resistances R1 and R2. Consequently, in the individual flow passage 23, an ink flow Fa toward the first supply opening 22 is greater than an ink flow Fb toward the second supply opening 32.

FIG. 4B is an explanatory diagram of the ink flow during the process of shrinkage of the bubble B. During the process of shrinkage of the bubble B, the ink flows in to compensate for a volume of the shrinkage. In such a case, as illustrated in FIG. 4B, an ink flow Fc flowing in from the first supply opening 22 on a side having the smaller flow resistance R1 is greater than an ink flow Fd flowing in from the second supply opening 32 on a side having the larger flow resistance R2. Further, a position where the bubble B collapses is shifted from above the circulation heater 24 toward the second supply opening 32.

FIG. 4C is an explanatory diagram illustrating the process after collapse of the bubble B. Due to a relationship Fc>Fd generated in FIG. 4B, a circulation flow F of ink from the first supply opening 22 toward the second supply opening 32 is generated.

A magnitude of such a circulation flow F depends on a ratio of flow resistances R1 and R2 and a size of the bubble B. For example, the following case may be considered as a premise: a circulation heater 24, which is an electro-thermal conversion element, is used as the second energy generating element 24. In particular, it is preferable that the second energy generating element 24 is located closer to one of the both end portions of the individual flow passage 23 than the first energy generating element. More specifically, it is preferable to set a flow resistance ratio R1/R2 in a range of 0.05 to 0.40. By setting the flow resistance ratio R1/R2 in the range, the circulation flow F can be maximized. It is desirable that the circulation flow F increases the ink flow Fa toward the first supply opening 22 illustrated in FIGS. 4A and 4B and increases the ink flow Fc flowing in from the first supply opening 22. Therefore, it is effective to reduce the flow resistance R1. Further, it is desirable to make the ink flow Fb toward the outflow flow passage 15 as small as possible and to reduce the ink flow Fd flowing in from the second supply opening 32. Therefore, it is effective to increase the flow resistance R2. Considering the above description, it is desirable to reduce the flow resistance R1 and increase the flow resistance R2, that is, to reduce the flow resistance ratio R1/R2. Further, a large bubble B, that is, a large bubble volume, leads to an increase in the volume of space excluding the fluid generated from the individual flow passage 23, and therefore increases the circulation flow F.

Means for increasing the bubble volume includes:
increasing a size of the circulation heater 24;
reducing the flow resistance by increasing a width and a height of the flow passage 13;
reducing an ink viscosity;
increasing a head temperature;
making driving pulses as double pulses;
   and the like.

Since a part of the circulation flow F of ink enters the ejection port 11, the concentrated ink in the ejection port 11 is sent to the second supply opening 32 side, and fresh ink flows into the ejection port 11 from the first supply opening 22 side through the connection flow passage 13. In such a manner, by making the concentrated ink less likely to remain in the ejection port 11, the concentrated ink can be prevented from having the effect. As a result, the initial ink ejection state can be maintained.

The circulation flow F is a transient flow that accompanies the process of growth and the process of shrinkage when the bubble B is generated. Therefore, the inertial flow of the bubble B after collapse attenuates over time and stops after a certain time period. Therefore, in order to steadily generate the circulation flow F for a certain time period, it is may be useful to repeatedly drive the heat generating element of the circulation heater 24. The driving cycle of the circulation heater 24 is not particularly limited as long as the concentrated ink in the ejection port 11 can be discharged. Here, due to the transient flow that accompanies the process of growth and the process of shrinkage when the bubble B is generated, the effect is reduced when the driving is performed at a high driving frequency such as 100 kHz (kilohertz), in consideration of the cycle of 10 us (microsecond), which is the time period from the generation of the bubble to its collapse. Accordingly, it is preferable to drive the circulation heater 24 at a period of, for example, about 100 Hz to several tens of kHz. Thus, the higher the driving frequency, the more the circulation flow F is stably maintained, and the greater the effect of discharging the concentrated ink. On the other hand, it may be useful to consider the rise in temperature of the ink due to the heat generated by the driving of the circulation heater 24. Therefore, it may be useful to drive the circulation heater 24 an appropriate number of times.

### Recirculation Concentration

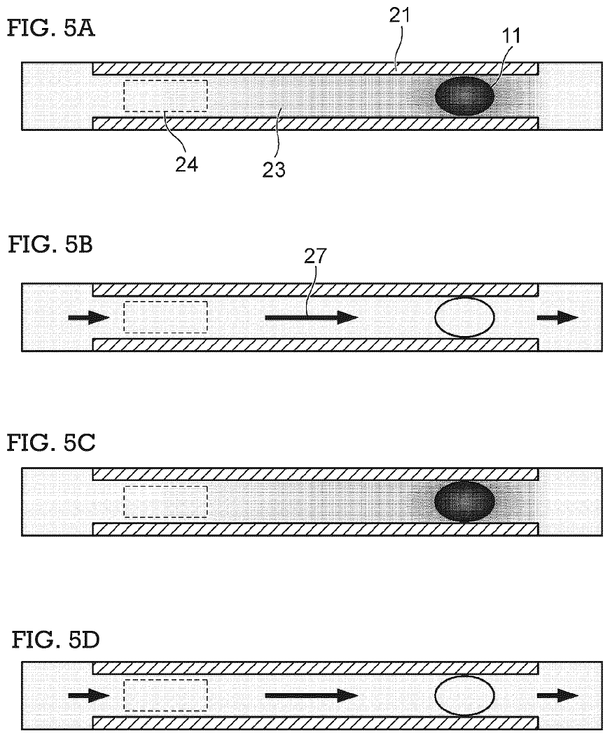

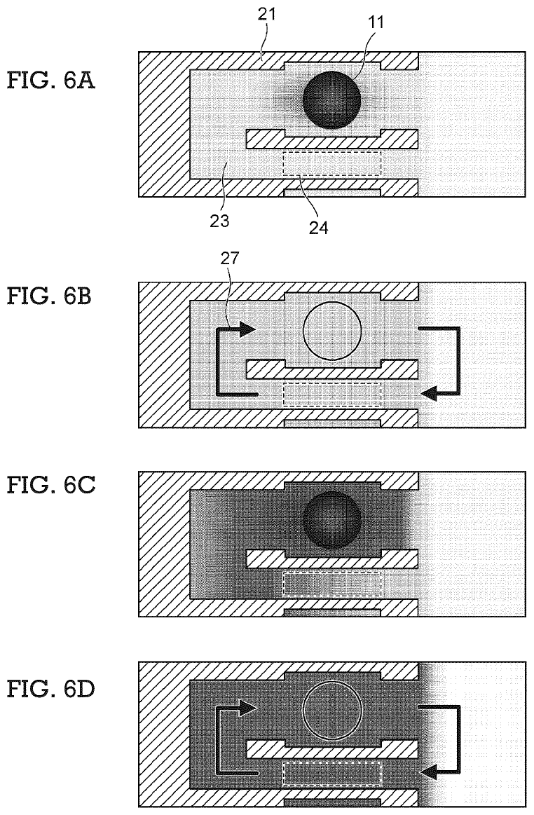

FIGS. 5A to 5D and FIGS. 6A to 6D are diagrams illustrating states of concentration elimination using the circulation flow of ink generated by the second energy generating element. FIGS. 5A to 5D show a straight type configuration in which the inlet and outlet of the circulation flow in the individual flow passage are separated. FIGS. 6A to 6D show a U-shape type configuration in which the inlet and outlet of the circulation flow in the individual flow passage are adjacent. The concentrated ink portion is shown in a dark color, and the concentration is expressed by the shade.

First, in FIGS. 5A to 5D, FIG. 5A shows a state of a temporary stop. During the temporary stop, volatile components evaporate from the ejection port portion, and the ink is concentrated in the vicinity of the ejection port. FIG. 5B shows a state immediately after the second energy generating element generates a circulation flow thereafter. The circulation flow eliminates the concentration in the vicinity of the ejection port. The ink concentrated in the vicinity of the ejection port is discharged from the outlet, and concentration is eliminated throughout the entire individual flow passage. FIG. 5C shows a state of a further temporary stop thereafter. As in FIG. 5A, the ink is concentrated again in the vicinity of the ejection port. FIG. 5D shows a state immediately after the second energy generating element generates a circulation flow therefrom. As in FIG. 5B, the concentration in the vicinity of the ejection port is eliminated again, and the concentration is eliminated in the entire individual flow passage. As described above, in a straight type where the inlet and outlet of the individual flow passage are separated, the state of concentration is reset each time the temporary stop and circulation operations are repeated.

On the other hand, in FIGS. 6A to 6D, FIG. 6A shows a state of the temporary stop. During the temporary stop, the ink is concentrated in the vicinity of the ejection port as in FIG. 5A. FIG. 6B shows a state immediately after the second energy generating element generates a circulation flow thereafter. Here, since the inlet and outlet of the individual flow passage are adjacent, the ink concentrated in the vicinity of the ejection port is discharged from the outlet, but flows again from the inlet. Thereby, the entire individual flow passage is replaced with slightly concentrated ink instead of fresh ink (hereinafter referred to as recirculation concentration). FIG. 6C shows a state of a further temporary stop thereafter. In such a case, in addition to the state illustrated in FIG. 6B, the ink is concentrated again in the vicinity of the ejection port as illustrated in FIG. 6A. The state illustrated in FIG. 6D is immediately after the second energy generating element generates a circulation flow therefrom. In such a case, as illustrated in FIG. 6B, due to the effect of recirculation concentration, the entire individual flow passage is replaced with more concentrated ink than in the state illustrated in FIG. 6B. As described above, in the U-shape type configuration in which the inlet and outlet of the individual flow passage are adjacent, the state of concentration is not reset each time the temporary stop and circulation operations are repeated, and the concentration gradually progresses throughout the individual flow passage, causing the state of concentration to deteriorate. Further, even when the circulation operation is not repeated, the ink may be highly concentrated in the vicinity of the ejection port due to a long stop time period or the like. In such a case, the state of concentration is unlikely to improve even in the first circulation operation. The reason for this is that the state of concentration is less improved in the recirculation concentration.

Therefore, in terms of the state of concentration elimination due to the temporary stop and circulation operations due to the difference in the effect of the discharged concentrated ink, there is a difference between the straight type in which the inlet and outlet of the individual flow passage are separated and the U-shape type in which the inlet and outlet of the individual flow passage are adjacent. In the straight type, the state of concentration is easily eliminated throughout the entire individual flow passage. Thus, the ejection stability is less likely to decrease due to concentrated ink. In contrast, in the U-shape type, the state of concentration is not easily eliminated throughout the entire individual flow passage in the recirculation concentration. Thus, the ejection is likely to become unstable due to the concentration of the entire individual flow passage.

### Ink

As described above, although the degree of concentration elimination differs in accordance with the difference in the flow passage configuration, the effect of the concentrated ink evaporated and thickened at the ejection port can be suppressed by generating the ink circulation flow in the individual flow passage using the second energy generating element. In other words, the ink ejection state can be satisfactorily maintained. Thus, the effects of changes in ejection speed and the like can be reduced, and the ejection is easily stabilized.

Meanwhile, it is assumed that the use of inks having different types of coloring materials and different solid content is used in accordance with the use of the liquid ejection head and the liquid ejection device on which the head is mounted. That is, it is preferable for the performance of the liquid ejection head to be able to maintain a high level of ejection stability regardless of the type of ink used. For example, it is considerable to use ink with a reduced water content to address issues, which may be caused by the water in the ink, such as curling (warping) and cockling (wavy wrinkles) on plain paper. Ink with a low water content has a high concentration of solids such as organic solvents, pigments, and resins other than water. Thus, a rapid increase in viscosity is likely to occur as the water evaporates, which is likely to lead to a decrease in ejection stability of the ink. For such inks, a method of generating a circulation flow in such a pressure chamber in the present disclosure is very effective because the method is able to suppress the increase in viscosity of the ink. Generally, an ink with a high solid content indicates a solid content of 10 wt %. That is, the present disclosure is suitable for application to inks with a solid content of 10 wt % (mass %) or more.

Further, the temperature at which the head operates may be heated to a constant temperature by causing heaters disposed over the entire chip to control the temperature. Since the ink viscosity changes depending on the temperature, the ink viscosity at the head operation temperature affects the ejection stability.

When the circulation flow using the second energy generating element is formed, the instantaneous flow speed of the circulation flow can be several tens of mm/s to 1000 mm/s. The average flow speed as viewed over a time span of the order of several hundreds of microseconds depends on the driving frequency of the circulation heater. The reason for this is that the circulation heater is a transient circulation flow that attenuates over time and stops after a certain time period. When the second energy generating element is driven at about 10 to 20 kHz, which is the same as the driving frequency (ejection frequency) of the first energy generating element, an average flow speed can be several mm/s to 100 mm/s.

When ink with a high pigment concentration, for example, ink with a viscosity of at least 3 cP and not more than 6 cP at the head operation temperature, is used, the viscosity of the ink tends to increase at the ejection port portion in accordance with the non-ejection time period (stop time period). Therefore, a change in ejection speed tends to occur, and the ejection stability tends to decrease. Therefore, it may be useful to circulate the ink during a short stop time period, and it may be useful to eliminate the concentration by performing steady ink circulation or transient ink circulation at a high frequency. When the circulation heater is used as the second energy generating element, the ink circulation is transient. Therefore, the circulation operation can be performed at a high frequency to contribute to eliminating the concentration at the ejection port portion.

In contrast, when ink with a low pigment concentration, for example, ink with a viscosity of at least 1 cP (centipoise) and not more than 2 cP at the head operation temperature, is used, the ejection speed may change depending on the non-ejection time period (stop time period). Here, the effect is relatively small compared to the effect of high-concentration ink. As the stop time period increases, the viscosity of ink increases at the ejection port portion in accordance with the non-printing drive time period (shutoff time period). Therefore, in order to restart printing after not printing and stopping for a certain time period, it may be useful to perform recovery processing associated with waste ink, such as a suction operation, a wiping operation, and preliminary ejection combined therewith. When the circulation heater is used as the second energy generating element, the circulation flow is formed to contribute the elimination of concentration at the ejection port portion without generating waste ink through the recovery operation. Depending on the shutoff time period, it is also possible to prevent waste ink from being generated through the recovery processing using only the circulation operation. Alternatively, it is also possible to perform the recovery processing of minimizing an amount of waste ink as much as possible by partially combining a suction operation for removal of bubbles in the head, which is separate from the concentration elimination, while performing the recovery by performing the circulation operation.

In both high-concentration ink and low-concentration ink, it is desirable to return the ink to an initial fresh state thereof as much as possible in order to suppress the effects of concentrated ink. Therefore, even when the circulation heater is used as the second energy generating element, the lower the effect of the recirculation concentration, the better the circulation effect can be obtained. In other words, a straight type configuration is more effective than a U-shape type configuration.

### First Embodiment

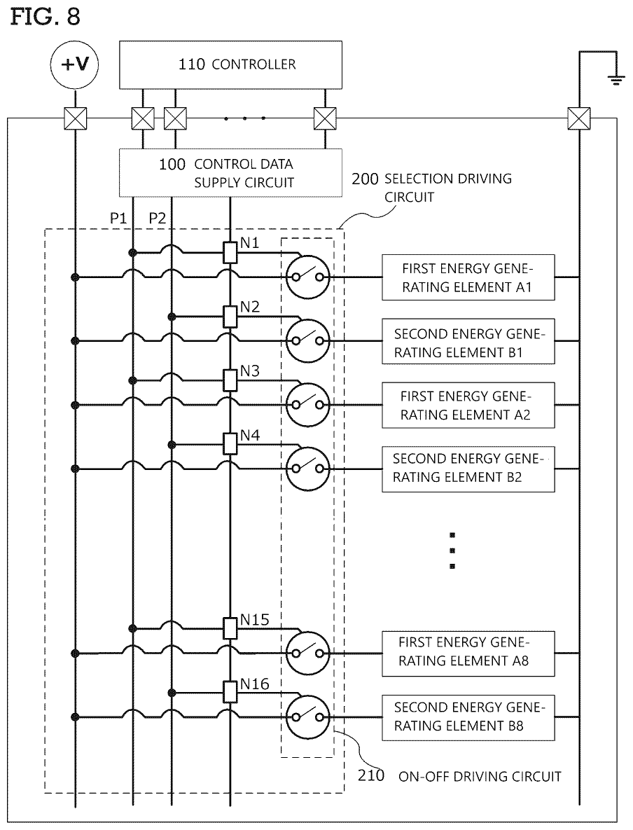

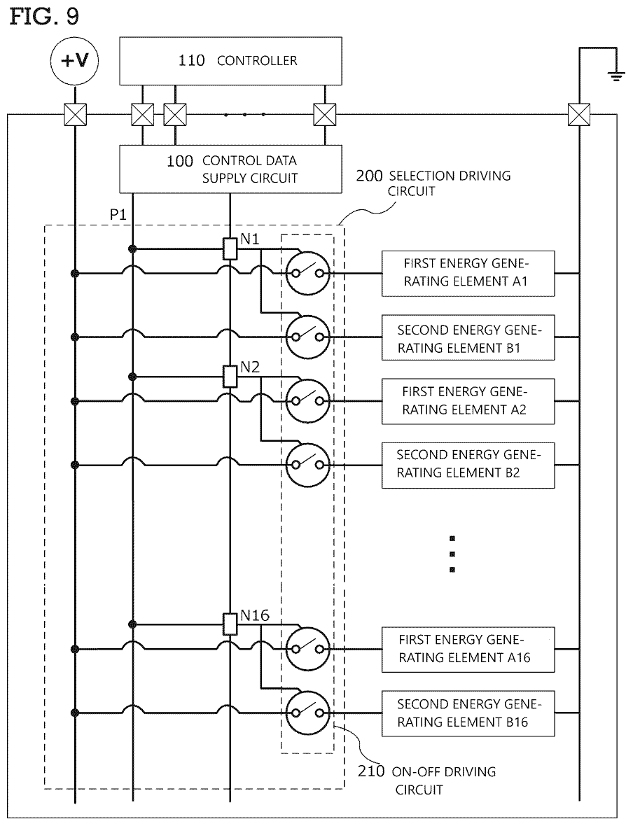

FIGS. 7A to 7C are schematic diagrams each illustrating in detail the vicinity of the ejection port of the liquid ejection head that ejects liquid such as ink in a first embodiment. FIG. 7A is a plan view as viewed from the direction in which liquid droplets are ejected from the ejection port. FIG. 7B is a cross-sectional view taken along the line A-B in FIG. 7A. FIG. 7C is an enlarged schematic diagram illustrating the names of elements in the individual flow passage portion in FIG. 7A. FIG. 8 is a block diagram illustrating the selection driving circuit configuration on the substrate in a comparative configuration. FIG. 9 is a block diagram illustrating the selection driving circuit configuration on the substrate in the present embodiment.

In FIGS. 7A and 7B, the ejection ports 11 for ejecting liquid are formed in the orifice plate 19. The first energy generating elements 14 are formed directly below the ejection ports 11 in the substrate 18. The second energy generating elements 24 are formed in the substrate 18 in the same manner as the first energy generating elements 14 to form the circulation flow 27 in the individual flow passage 23. The liquid is supplied from the supply groove 42 to the individual flow passages 23 including the ejection ports 11. In such a case, both ends of the individual flow passages are adjacent in the first direction, which is a direction in which the ejection ports are arranged.

Here, in a system referred to as a U-shape type based on the flow passage shape illustrated in FIG. 7A, both ends of the individual flow passages are adjacent in the first direction, which is the direction in which the ejection ports are arranged. The names of the elements used in FIGS. 8, 9, and 10 will be described. As illustrated in FIG. 7C, each individual flow passage 23 is provided with the first energy generating element 14 and the second energy generating element 24. In order to distinguish between the elements, the first energy generating element is represented by Ai (i=1, 2, 3, . . . , n), and the second energy generating element is represented by Bi (i=1, 2, 3, . . . , n). In such a case, it is indicated that, for example, A1 and B1 are in the same individual flow passage.

### Driving Method in Comparative Configuration

In the comparative configuration, a selection driving circuit 200 as illustrated in FIG. 8 is formed on the substrate 18. A voltage source (+V) and a controller 110 are provided outside of the substrate and connected to the selection driving circuit 200 on the substrate. In response to a control signal at each address (N1 to N16 in the present configuration) received from the control data supply circuit 100, an on-off driving circuit (on-off changeover switch) 210 is included, which drives the first energy generating elements (A1 to A8) or the second energy generating elements (B1 to B8) on or off. That is, the first energy generating element and the second energy generating element are each independently controlled by a switch configured to be switchable between a drivable state and a non-drivable state. Here, the control data supply circuit controls separate driving pulses (P1, P2), which are for driving the first energy generating element or the second energy generating element, and the time interval, which is for applying the driving pulses to each element at separate driving timings.

In the comparative configuration, the first energy generating element and the second energy generating element are associated with separate addresses, and the first energy generating element and the second energy generating element are driven together in a distributed manner. In a case of using eight first energy generating elements and eight second energy generating elements as in this comparative configuration, the driving timing is shifted in 16 time-divisions, reducing instantaneous power and obtaining averaged power. The time shifted for each time-division depends on the number of time-divisions and the driving frequency, but is on the order of several us to 10 us. In the case of a larger number of energy generating elements, time-division blocks are formed in 16 time-divisions, and a delay is provided for each time-division block. Thus, in addition to the 16 time-divisions, the driving timings of energy generating elements with the same number of time-divisions are slightly different. In such a manner, instantaneous power can be further reduced and averaged power can be obtained. In such a case, the delay time to be shifted for each time-division block is on the order of several ns, and gradually shifts depending on the number of time-division blocks, but the maximum shift is about several hundred ns to 1000 ns.

Further, it is possible to set separate driving pulses for the first energy generating element used for ejection and the second energy generating element used for circulation. The driving pulses are given to each energy generating element at a plurality of driving timings. In such a manner, it is possible to control the optimal driving pulse for each energy generating element and give the driving pulse at each driving timing. On the other hand, wiring is used to give separate driving pulses to the first energy generating element and the second energy generating element. In addition to a circuit for time-division driving according to the total number of energy generating elements, a circuit for shifting the driving timing to give a delay may be provided. Therefore, the circuit size may increase in accordance with the type and total number of energy generating elements.

### First Driving Circuit of Embodiment

In the present embodiment, a selection driving circuit 200 as illustrated in FIG. 9 is formed on the substrate 18. The voltage source and the controller 110 are provided outside of the substrate and connected to the selection driving circuit 200 on the substrate. The selection driving circuit 200 includes an on-off driving circuit (on-off changeover switch) 210 that drives each of the first energy generating elements (A1 to A16) and the second energy generating elements (B1 to B16) on or off in response to a control signal at each address (N1 to N16 in the present embodiment) received from the control data supply circuit 100. That is, each of the first energy generating elements and the second energy generating elements is independently controlled by a switch that is configured to be switchable between a drivable state and a non-drivable state.

Here, the control data supply circuit 100 controls a common driving pulse (P1) that drives the first energy generating element or the second energy generating element, and a time interval for applying the common driving pulse to each element at a common driving timing. Here, the first energy generating element and the second energy generating element in the same individual flow passage each have the common driving timing without a delay, and are represented by sharing the same address. For example, the address N1 corresponds to a set including the first energy generating element Al and the second energy generating element B1.

In the configuration of the present embodiment, first, the wiring can be shared, and the circuit size for the wiring can be reduced, by using a common driving pulse for the first energy generating element and the second energy generating element. In the first energy generating element used for ejection, the driving has great effects on printing of the printed texts, images, and the like to be output. Accordingly, highly accurate pulse control may be used. On the other hand, in the second energy generating element used for circulation, if a circulation flow occurs, a slight increase or decrease in the circulation flow rate has almost no effect on the printing. Accordingly, highly accurate pulse control may not be necessary. For example, when the circulation heater is used as the second energy generating element, if bubbles are generated, the circulation flow occurs. Accordingly, highly accurate pulse control may not be necessary as in the first energy generating element.

Further, in the second energy generating element, the driving energy applied for the circulation can be lower than the normal driving energy applied for the ejection. For example, when a circulation heater is used as the second energy generating element, the circulation flow occurs when bubbles are generated. Accordingly, the driving energy may not be necessary to the same extent as that of the first energy generating element. In addition, in the ejection heater, more driving energy is generally applied to stably generate film boiling and stabilize ejection, compared to the energy used to generate film boiling. In contrast, from the viewpoint that it is desirable to generate the circulation flow, although it may be useful to generate bubbles, the driving energy can be reduced to a certain extent. Here, when the heater is used as the energy generating element, it is known that kogation based on ink components accumulates on the heater surface depending on the number of times of the driving. This is similar to the case where the circulation heater is used as the second energy generating element. When the driving energy is lowered, the amount of excess energy applied to this kogation is reduced, and the kogation effect is reduced. Therefore, from this viewpoint, it is preferable to lower the driving energy in the circulation heater.

Next, by setting the first energy generating element and the second energy generating element in the same individual flow passage to a common driving timing without delay, the circuit that shifts the driving timing to generate the delay and gives a driving pulse is halved. As a result, the circuit size can be reduced accordingly. Since the driving timing is the same for the first energy generating element and the second energy generating element in the same individual flow passage without delay, if both are selected, both will be driven at exactly the same timing. However, it may not be necessary to simultaneously drive the first energy generating element used for ejecting and the second energy generating element used for circulation in the same individual flow passage. Thus, there is no problem as a common driving timing at which the elements are simultaneously driven.

Here, a certain individual ejection unit included in the liquid ejection head is set as the first individual ejection unit, and another individual ejection unit is set as the second individual ejection unit. In such a case, the first energy generating element and the second energy generating element included in the first individual ejection unit are driven at the same timing (first timing). Moreover, the first energy generating element and the second energy generating element included in the second individual ejection unit are driven at the same timing (second timing). However, the first timing and the second timing do not necessarily have to be the same timing. By controlling the first timing and the second timing to be different timings, it is possible to reduce the power flowing through the circuit at one time. As might be expected, the number of individual ejection units is not limited to two, and the liquid ejection head may have three or more individual ejection units.

In summary, in the first driving circuit of the present embodiment, the first energy generating element and the second energy generating element share a driving pulse, and the first energy generating element and the second energy generating element in the same individual flow passage have a common driving timing without delay, thereby reducing the circuit size.

Further, the first energy generating element and the second energy generating element do not necessarily have the same energy generating element size. When the first energy generating element used for ejection and the second energy generating element used for circulation use different sizes of energy generating elements, an aspect ratio of the energy generating element can be adjusted to use the same driving pulse. Alternatively, when the energy generating element is a heater, the sheet resistance value can be changed to use the same driving pulse.

Further, as described above, it is conceivable that the second energy generating element used for circulation has a lower driving energy than the normal driving energy for ejection. In other words, the circulation driving of the second energy generating element may be driven with lower energy than the ejection driving of the first energy generating element. Even when the driving energy of the second energy generating element is reduced, the size and aspect ratio of the energy generating element can be adjusted accordingly. For example, the size of the second energy generating element can be made less than the size of the first energy generating element. Furthermore, for example, when the first energy generating element and the second energy generating element are thin-film resistors, the second energy generating element may be designed to be smaller than the first energy generating element in at least one dimension of the longitudinal and lateral dimensions. Moreover, for example, when the first energy generating element and the second energy generating element are thin-film resistors, a sheet resistance value of the second energy generating element may be designed to be less than a sheet resistance value of the first energy generating element.

### Second Driving Circuit of Embodiment

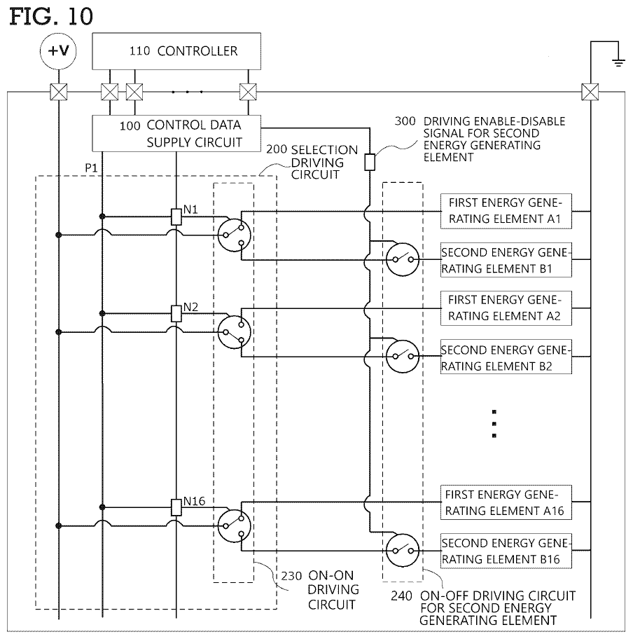

In the second form of the present embodiment, a selection driving circuit 200 as illustrated in FIG. 10 is formed on the substrate 18. The voltage source and the controller 110 are provided outside of the substrate and connected to the selection driving circuit 200 on the substrate. The selection driving circuit 200 includes an on-on driving circuit (first switch for on-on changeover) 230 that turns on and drives either the first energy generating elements (A1 to A16) or the second energy generating elements (B1 to B16) in response to the control signal at each address (N1 to N16 in the present embodiment) received from the control data supply circuit 100. That is, the selection driving circuit 200 has a switch configured to be mutually exclusively switchable such that only one of the first energy generating element and the second energy generating element is in a drivable state. By using such a switch, when the first energy generating element is in a drivable state, the second energy generating element may be in a non-drivable state. In contrast, when the second energy generating element is in a drivable state, the first energy generating element may be in a non-drivable state.

Here, the control data supply circuit controls a common driving pulse (P1) that drives the first energy generating element or the second energy generating element, and a time interval for applying the common driving pulse to each element at a common driving timing. Here, the first energy generating element and the second energy generating element in the same individual flow passage each have the common driving timing, and are represented by sharing the same address. For example, the address N1 corresponds to a set including the first energy generating element A1 and the second energy generating element B1.

Even when the second energy generating element side is selected in the on-on driving circuit 230, the on-off driving circuit (second switch for on-off changeover) 240 for the second energy generating element controls the driving in response to the driving enable-disable signal 300 for the second energy generating element. That is, a switch, which is configured to be switchable between a drivable state and a non-drivable state, further controls the second energy generating element. Therefore, if the first energy generating element is in a non-drivable state, the second energy generating element is in a drivable state, but is actually driven only when receiving a driving signal (driving enable-disable signal) instructing the second energy generating element to be driven. If there is no driving enable-disable signal, the second energy generating element is not driven even when the second energy generating element side is selected in the on-on driving circuit 230. That is, in such a case, neither the first energy generating element nor the second energy generating element is driven.

In summary, in the second driving circuit of the present embodiment, the driving circuit for controlling the driving of the first energy generating element and the second energy generating element has a first switch configured to be mutually exclusively switchable between the first energy generating element and the second energy generating element such that only one thereof is in a drivable state, and a second switch configured to be able to switch the second energy generating element between the drivable state and the non-drivable state. The driving circuit is characterized in that the driving circuit is used to drive and control the first energy generating element and the second energy generating element under the following conditions.

Conditions: The second energy generating element is not driven in a case where the first energy generating element is driven, and the second energy generating element is driven in response to receiving a driving signal instructing the driving of the second energy generating element in a case where the first energy generating element is not driven.

Further, it is preferable that the on-off driving circuit (second switch) is provided on the side closer to the second energy generating element than the on-on driving circuit (first switch), that is, on the electrically downstream side of the second energy generating element. Furthermore, it is preferable to drive and control the plurality of second energy generating elements using the common driving signal.

For comparison, measures against ink of which the viscosity is increased in the liquid ejection head that does not form a circulation flow will be described below. Examples of the measures include the preliminary ejection operation that ejects ink from the ejection port and the suction operation that sucks ink from the ejection port. For example, in a serial type liquid ejection device, the preliminary ejection operation or the suction operation is performed in a head standby region before moving away from a cap that protects the head and advancing to a printing operation. Alternatively, the preliminary ejection operation is performed in a non-printing region that is deviated from the print medium when the carriage moves back and forth for the printing operation. The operations are performed at different timings from the printing operation. Further, in the case of ink of which the viscosity tends to increase, the preliminary ejection operation may be performed in addition to the printing operation in the printing region during the reciprocating movement to an extent that does not affect the image on the printing medium.

In the second driving circuit of the present embodiment, the number of preliminary ejection operations and the number of suction operations can be reduced by performing a circulation operation through driving of the second energy generating element. In such a case, the circulation operation in the head standby region or the non-printing region during reciprocating movement is also at a different timing from the printing operation. Therefore, in the second driving circuit of the present embodiment, the driving of the second energy generating element can be easily controlled by the driving enable-disable signal 300 for the second energy generating element. Further, in the case of ink of which the viscosity tends to increase, in the circulation operation in the printing region of the reciprocating movement, the timing of the ejection operation may be prioritized among the timings of operations close to the timing of the printing operation. On the other hand, by providing a plurality of timings for the circulation operation or providing a certain time period, it may not be necessary to drive the circulation operation and the printing operation simultaneously. Therefore, in the second driving circuit of the present embodiment, when the first energy generating element side is selected, the first energy generating element is driven, such that the circulation operation can be appropriately controlled without having an effect on the printing operation.

In summary, in the second driving circuit of the present embodiment, as in the first driving circuit, the driving pulses are shared between the first energy generating element and the second energy generating element, and the driving timings of the first energy generating element and the second energy generating element in the same individual flow passage are shared in order to exclusively control the driving timings, thereby reducing the circuit size. Further, the second energy generating element is driven and controlled in accordance with the driving data and driving enable-disable signal for the first energy generating element. Thereby, it may not be necessary to provide driving data for the second energy generating element. As a result, there is an advantage in that the circuit size is further reduced accordingly.

Further, even when there are the plurality of second energy generating elements, it is possible to control the driving on the basis of a common driving enable-disable signal. Furthermore, in the first driving circuit and the second driving circuit of the present embodiment, the first energy generating elements Ai and the second energy generating elements Bi which are a total of 32 elements (16 pairs) when n=16 are controlled as one group. For example, the total number of elements as one group may be set to various numbers such as 16 (8 pairs), 24 (12 pairs), and the like.

In the present embodiment, the driving enable-disable signal 300 may control the driving of the second energy generating elements by being provided to the substrate 18, but may control the driving of the second energy generating elements by being provided to the liquid ejection head outside of the substrate or the liquid ejection device outside of the liquid ejection head.

### Second Embodiment

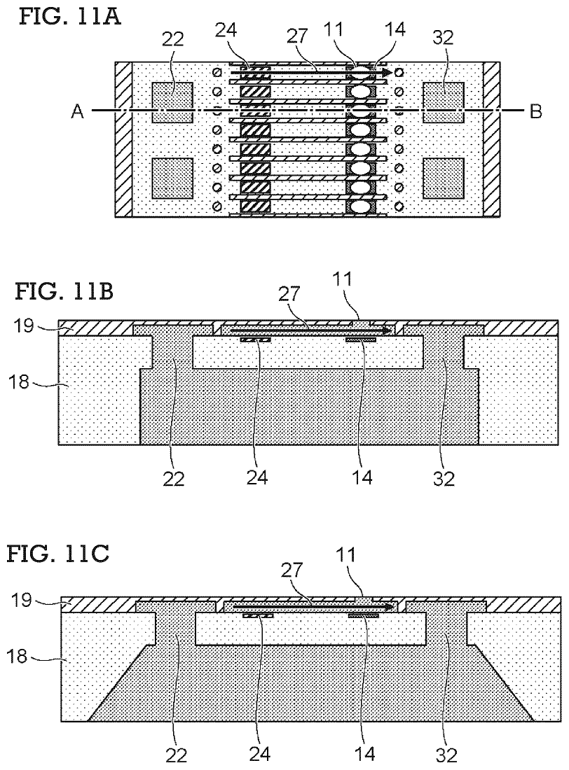

FIGS. 11A to 11C are schematic diagrams each illustrating in detail the vicinity of the ejection port of the liquid ejection head that ejects liquid such as ink in a second embodiment. FIG. 11A is a plan view as viewed from the direction in which liquid droplets are ejected from the ejection port. FIGS. 11B and 11C are two examples of the cross-sectional view taken along the line A-B in FIG. 11A.

Here, FIGS. 11B and 11C show two examples in which the shape of the rear side of the substrate changes in accordance with the type of the method for etching the substrate, but the cross-section may have either shape.

The present embodiment and the first embodiment are different as compared to each other in a straight type configuration in which the inlet and outlet of the individual flow passage are separated. In the present embodiment, both ends of the individual flow passage are separated and disposed at opposite positions in the second direction perpendicular to the first direction in which the ejection ports are arranged.

An advantage of such a configuration is as follows. The inflow and outflow of the circulation flow are separated in the opposite directions. Thus, ink concentrated at the ejection port portion due to circulation does not re-flow into the individual flow passage, thereby suppressing the effect of concentration.

### Third Embodiment

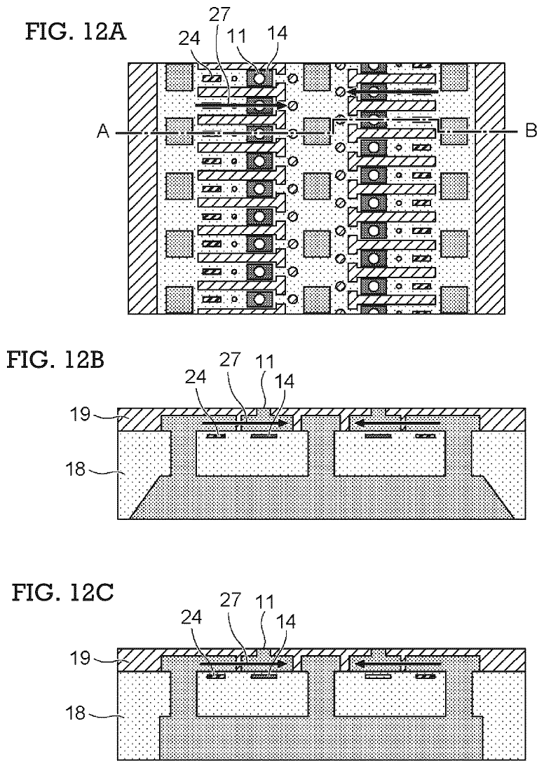

FIGS. 12A to 12C are schematic diagrams each illustrating in detail the vicinity of the ejection port of the liquid ejection head that ejects liquid such as ink in a third embodiment. FIG. 12A is a plan view as viewed from the direction in which liquid droplets are ejected from the ejection port. FIGS. 12B and 12C are two examples of the cross-sectional view taken along the line A-B in FIG. 12A, which are similar to FIGS. 11B and 11C.

The difference between the present embodiment and the second embodiment compared to each other is as follows. The number of ejection port rows is doubled by providing three supply opening rows and each of the ejection port rows is located closer to the central supply opening row. That is, the ejection port rows are formed on both sides of the plurality of supply openings in the direction of arrangement thereof. Each of the ejection port rows may be referred to as a first ejection port row and a second ejection port row.

An advantage of such a configuration is that the number of ejection port rows can be doubled from one row to two rows by increasing the number of supply openings from two rows to three rows by 1. Two ejection port rows may be disposed to be deviated by a pitch as illustrated in the figure. Further, a configuration is possible in which no wiring region is used between the openings in the central supply opening row, and the degree of freedom is high in the size and resolution of the openings in the central supply opening row. Thereby, it is easy to achieve high productivity by rapidly refilling the nozzles.

In the present embodiment, the three supply opening rows are at the same positions in the direction between the nozzle rows, but each row may be shifted in accordance with the nozzle position and laying of the wiring between the openings. The same configuration may also be applied to the following embodiments.

### Fourth Embodiment

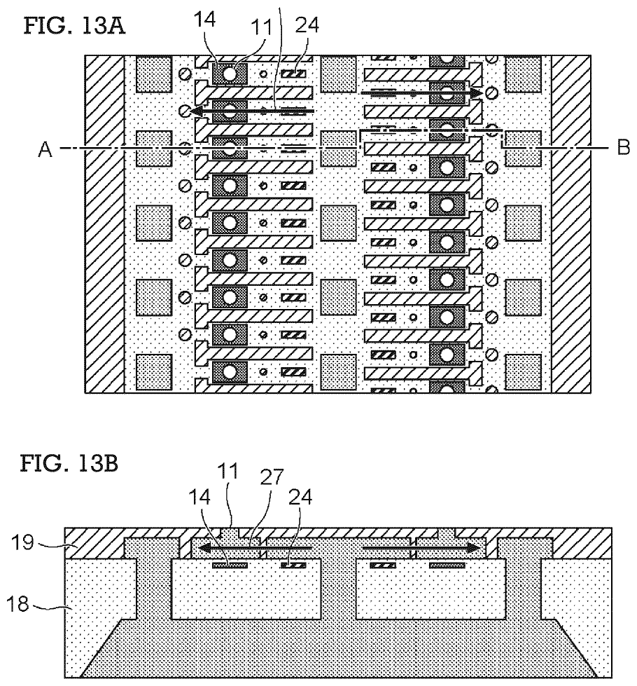

FIGS. 13A and 13B are schematic diagrams each illustrating in detail the vicinity of the ejection port of the liquid ejection head that ejects liquid such as ink in a fourth embodiment. FIG. 13A is a plan view as viewed from the direction in which liquid droplets are ejected from the ejection port. FIG. 13B is a cross-sectional view taken along the line A-B in FIG. 13A.

The difference between the present embodiment and the third embodiment compared to each other is as follows. The direction of the circulation flow is reversed by providing the ejection port rows on the sides closer to the supply opening rows on both sides and providing the second energy generating element on the side closer to the central supply opening row.

An advantage of such a configuration is as follows. The ink concentrated in the vicinity of the ejection port is diverted and discharged to the supply opening rows on both sides, suppressing the effect of concentrated ink when the ink re-flows into the individual flow passages depending on ejection or the like. Further, the ejection port rows are disposed to be separated from each other, suppressing the effect of interference caused by meniscus vibration caused by ejection from each ejection port.

### Fifth Embodiment

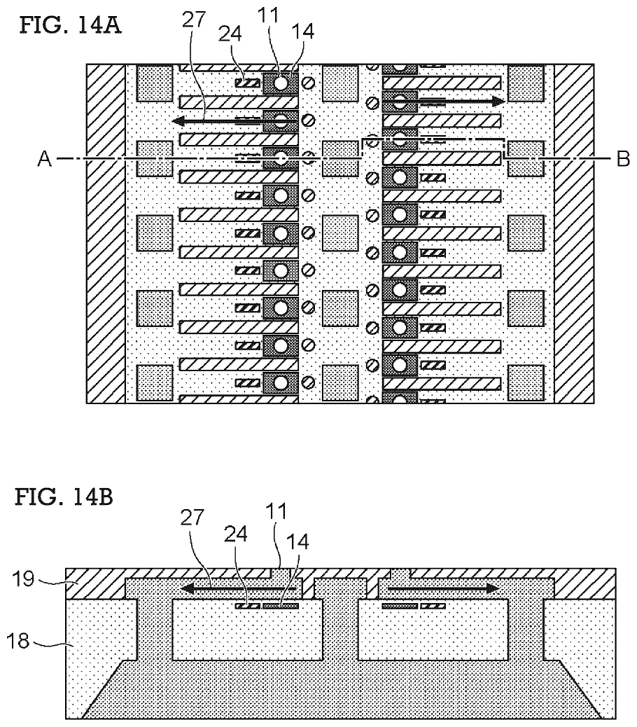

FIGS. 14A and 14B are schematic diagrams each illustrating in detail the vicinity of the ejection port of the liquid ejection head that ejects liquid such as ink in a fifth embodiment. FIG. 14A is a plan view as viewed from the direction in which liquid droplets are ejected from the ejection port. FIG. 14B is a cross-sectional view taken along the line A-B in FIG. 14A.

The difference between the present embodiment and the third embodiment is as follows. The second energy generating element is close to the first energy generating element, and the second energy generating element is closer to the central supply opening row than the supply openings on both sides, thereby reversing the direction of the circulation flow.

An advantage of such a configuration is as follows. As in the third embodiment, the degree of freedom is high in the size and resolution of the central supply opening row, making it easier to achieve high productivity by rapidly refilling. In addition, the ink concentrated in the vicinity of the ejection port is branched off and discharged to the supply opening rows on both sides, suppressing the effect of concentrated ink when the ink re-flows into individual flow passages depending on ejection or the like.

### Sixth Embodiment

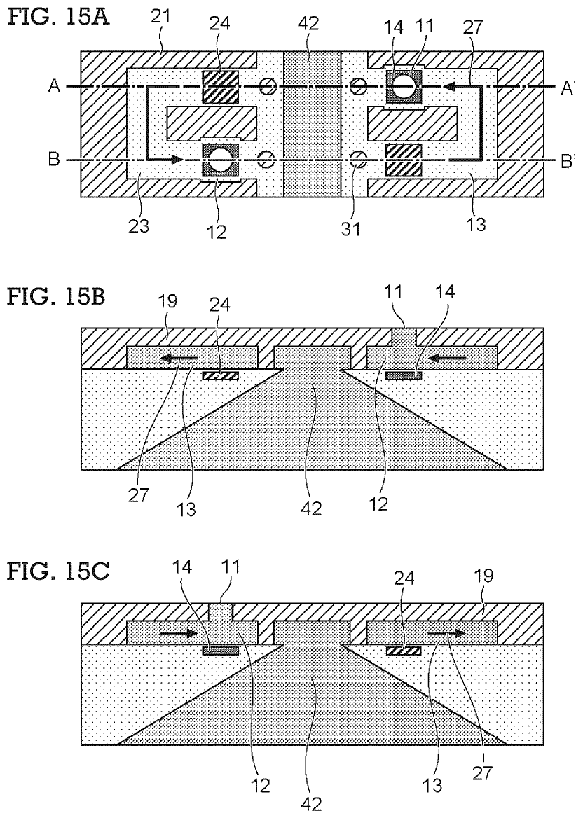

FIGS. 15A to 15C are schematic diagrams each illustrating in detail the vicinity of the ejection port of a liquid ejection head that ejects liquid such as ink in a sixth embodiment. FIG. 15A is a plan view as viewed from the direction in which liquid droplets are ejected from the ejection port. FIGS. 15B and 15C are cross-sectional views taken along the lines A-A′ and B-B′ in FIG. 15A, respectively.

The difference between the present embodiment and the first embodiment compared to each other is as follows. The left and right ejection port rows with the supply groove interposed therebetween are disposed in a staggered manner, and a filter is also provided at the inlet of the individual flow passage (in the vicinity of the second energy generating element). Even in such a configuration, the effect of the present disclosure can be obtained in the same manner.

As mentioned at the beginning, the present disclosure has an object to optimize the driving pulse and driving timing in order to reduce the circuit size in the ink circulation type liquid ejection head that uses both the ejection energy generating element and the flow energy generating element. To achieve the object, in the present disclosure, the common driving pulse is used when the first energy generating element and the second energy generating element are used. Typically, the ejection energy generating element and the flow energy generating element are driven by a single driving pulse. Further, the ejection energy generating element and the flow energy generating element in the same circulation path are driven at the common driving timing without delay. Thereby, the circuit size is suppressed.

According to the present disclosure, the circuit size can be reduced in the ink circulation type liquid ejection head that uses both the ejection energy generating element and the flow energy generating element.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-144361, filed Aug. 26, 2024, which is hereby incorporated by reference herein in its entirety.

What is claimed is:

1. A liquid ejection head comprising:
a first individual ejection unit; a second individual ejection unit; and a common flow passage,
wherein the first individual ejection unit and the second individual ejection unit each include
an ejection port configured to eject liquid,
a pressure chamber that communicates with the ejection port,
a first energy generating element that is provided in the pressure chamber and configured to generate energy for ejecting the liquid from the ejection port,
an individual flow passage that communicates with the pressure chamber, and
a second energy generating element that is provided in the individual flow passage,
wherein the common flow passage supplies the liquid to the individual flow passage for each of the first individual ejection unit and the second individual ejection unit,
wherein the first energy generating element and the second energy generating element in each of the first individual ejection unit and the second individual ejection unit are all driven by a common driving pulse,
wherein the first energy generating element and the second energy generating element in the first individual ejection unit are driven at a first same timing which is a first timing,
wherein the first energy generating element and the second energy generating element in the second individual ejection unit are driven at a second same timing which is a second timing, and
wherein the first timing and the second timing are controlled to be different from each other.

2. The liquid ejection head according to claim 1, wherein the first energy generating element and the second energy generating element are thin-film resistors, and are different in at least one dimension of longitudinal and lateral dimensions.

3. The liquid ejection head according to claim 1, wherein the first energy generating element and the second energy generating element are thin-film resistors, and sheet resistance values thereof are different.

4. The liquid ejection head according to claim 1, wherein the second energy generating element performs circulation driving for circulating the liquid in the individual flow passage, and the first energy generating element performs ejection driving for ejecting the liquid from the ejection port.

5. The liquid ejection head according to claim 4, wherein the circulation driving is driving with weaker energy than the ejection driving.

6. The liquid ejection head according to claim 1, wherein only one of the first energy generating element and the second energy generating element belonging to the same individual ejection unit are selectively controlled in an exclusive manner to be driven at the same timing.

7. The liquid ejection head according to claim 1, comprising a plurality of individual ejection units each of which includes the first individual ejection unit and the second individual ejection unit,
wherein a plurality of the ejection ports belonging to the plurality of individual ejection units form an ejection port row.

8. The liquid ejection head according to claim 1, wherein the common flow passage is connected to a plurality of the individual flow passages belonging to the plurality of individual ejection units, through an opening.

9. The liquid ejection head according to claim 7, wherein the first energy generating element and the second energy generating element are disposed in the individual flow passage of each of individual ejection units in a direction intersecting with the ejection port row.

10. The liquid ejection head according to claim 9, wherein the individual flow passages extend in the direction intersecting with the ejection port row such that both end portions of the individual flow passage are located with the ejection port row interposed therebetween.

11. The liquid ejection head according to claim 10, wherein one ends of a plurality of the individual flow passages of the plurality of individual ejection units are connected to the common flow passage through a plurality of first openings arranged along the ejection port row, and the other ends of the plurality of the individual flow passages are connected to the common flow passage through a plurality of second openings arranged along the ejection port row.

12. The liquid ejection head according to claim 11, wherein a first ejection port row and a second ejection port row are formed on both sides of the second openings in a direction of arrangement of the plurality of second openings.

13. The liquid ejection head according to claim 12, wherein a plurality of the first energy generating elements are disposed closer to the plurality of second openings in the plurality of the individual flow passages.

14. The liquid ejection head according to claim 12, wherein a plurality of the second energy generating elements are disposed closer to the plurality of second openings in the plurality of the individual flow passages.

15. The liquid ejection head according to claim 7, wherein the first energy generating element and the second energy generating element are disposed along the ejection port row in at least one of the plurality of the individual flow passages.

16. The liquid ejection head according to claim 15, wherein the individual flow passage is configured such that both end portions thereof are located on a single side of the ejection port row.
